(19) United States
(12) Patent Application Publication
(10) Pub. No.: US 2020/0338509 A1
(43) Pub. Date: Oct. 29, 2020

(54) VIBRATION TRANSFER ENGAGEMENT ELEMENT, LINEAR ACTUATOR AND CAROUSSEL ARRANGEMENT

(71) Applicant: Instrunor AS, Bjørnemyr (NO)

(72) Inventor: Torstein LJUNGMANN, Nesoddtangen (NO)

(21) Appl. No.: 16/758,385

(22) PCT Filed: Oct. 18, 2018
(86) PCT No.: PCT/NO2018/050248

§ 371 Date: Apr. 22, 2020

(30) Foreign Application Priority Data
Oct. 23, 2017 (NO) 20171694
Nov. 7, 2017 (NO) 20171765

(51) Int. Cl. B01F 11/00; B01L 9/06

(52) U.S. Cl. CPC B01F 11/0008; B01F 11/0017; B01L 2400/0409; B01L 9/06; B01F 2215/0037; B01F 11/0037

(57) ABSTRACT

The present invention relates to a test tube vibration transfer engagement element adapted to be linearly movable forward, X-direction, and in reverse, −X-direction, adapted to transfer vibrations in X-direction and −X-direction to test tubes. Moreover, it is disclosed a test tube linear shake actuator, a test tube linear shake actuator and carousel arrangement and a method for vibration transfer from a vibration transfer engagement element to a test tube included in a carousel arrangement.

### TECHNICAL FIELD

The present invention relates to means for vibrating test tubes, arrangement including said means and methods for operating said arrangement.

### BACKGROUND ART

In hospitals and labs centrifuging and mixing of test samples in test tubes using centrifuges is common, following a centrifuging step removal of supernatant in test tubes can be necessary.

When test samples are mixed into test tubes and centrifuged the centrifuging step can lead to phase separation and parts of the test samples can stick to the test tube. Normally, residues that has sticked to the test tube is loosened by manually shaking the test tube.

One object of the present invention is to overcome the problems with test samples being sticked to test tubes.

### DISCUSSION OF THE INVENTION

It is an object according to the present invention to provide a vibration transfer engagement element, a linear shake arrangement including the vibration transfer engagement element, a carousel arrangement including the linear shake arrangement and a method for operation of the linear shake arrangement.

It is disclosed a test tube vibration transfer engagement element adapted to be linearly movable forward, X-direction, and in reverse, −X-direction, adapted to engage with a test tube and thereby transfer vibrations in X-direction and −X-direction to test tubes.

The vibration transfer engagement element can be a U-shaped bracket with a first sheet metal side edge opposite to a second sheet metal side edge that forms the side edges of the bracket the first sheet metal side edge has a free end and a base end, the second sheet metal side edge has a free end and a base end, between the base end of the first sheet metal side edge and the base end of the second sheet metal side edge it is an intermediate planar piece (base?) with a first and a second open end, where the transfer engagement element has:
a) an opening A between the free end of the first sheet metal side edge and the free end of the second sheet metal side edge that is larger than the diameter of a closed end of a test tube and smaller than an axial length of the test tube,
b) a height E between 5 mm and 25 mm, and
c) a width D within the range of 1-15 mm.

In another aspect of the invention the vibration transfer engagement element is a U-shaped bracket with a first planar side edge opposite to a second planar side edge that forms the side edges of the bracket, the first planar side edge has a free end and a base end, the second planar side edge has a free end and a base end, between the base end of the first planar side edge and the base end of the second planar side edge it is an intermediate planar piece with a first and a second open end, where the transfer engagement element has:
a) an opening A between the free end of the first planar side edge and the free end of the second planar side edge that is larger than the diameter of a closed end of a test tube and smaller than an axial length of the test tube,
b) a height E between 5 mm and 25 mm, and
c) a width D within the range of 1-15 mm.

In one aspect of the invention, the side edges of the vibration transfer engagement element are mutually movable in X-direction and −X-direction; thereby achieving an adjustable opening width A, in another aspect the vibration transfer engagement element can be configured to be replaceable.

In yet an aspect of the invention opposite sides of the first side edge and the second side edge can be provided with a damping material.

In yet an aspect of the invention the vibration transfer engagement element can be a buzzer, where the buzzer can be one of electromechanical, mechanical and piezoelectric.

In yet an aspect of the invention the transfer engagement element can comprise a vibration transfer diaphragm, where a linear motor drives the diaphragm and the linear motor can be one of:
a) a moving coil type, of the type known from loudspeakers, and
b) a moving magnet type.

In yet an aspect of the invention the transfer engagement element includes a driving means being a secondary of a linear motor.

According to the invention it is disclosed a test tube linear shake actuator linearly movable forward, X-direction, and in reverse, −X-direction, having a first and second end comprising:
a) a vibration transfer engagement element proximate to the first end for vibration transfer engagement, suitable for vibration engagement with test tubes,
b) linear shake actuator driving means for moving the linear shake actuator in the X-direction and in the −X-direction, and
c) control means controlling:
   i. forward distance travel and reverse distance travel of the linear vibration transfer engagement element;
   ii. time sequences for travel between extremities in x-direction and in −X-direction of the linear vibration transfer engagement element, and
   iii. acceleration of the of the linear vibration transfer engagement element.
a) In yet an aspect of the test tube linear shake actuator the transfer engagement element can be a U-shaped bracket of the type indicated above for the vibration transfer engagement element.

In yet an aspect of the test tube linear shake actuator the linear shake actuator may further comprise a rack and pinion arrangement, where the rack includes the first and the second end, and where the pinion is in engagement with the rack for forward and reverse motion of the vibration transfer engagement element.

In yet an aspect of the test tube linear shake actuator the vibration transfer engagement element can be arranged with the first and second open end edges of the intermediate planar plane parallel to the longitudinal direction of the rack.

In yet an aspect of the test tube linear shake actuator the vibration transfer engagement element can be arranged with the first and second open end edges of the intermediate planar plane with an angle between the longitudinal direction of the rack and the first and second open end edges of the intermediate planar plane of +/−0-20°.

In yet an aspect of the test tube linear shake actuator where the linear shake actuator can be a chain drive actuator, where the endless chain is driven by driving means at the first end and the second end and the vibration transfer engagement element is fixed to an outer perimeter of the endless chain.

In yet an aspect of the test tube linear shake actuator the vibration transfer engagement element can be arranged with the first and second open end edges of the intermediate planar plane with an angle between the longitudinal direction of the endless chain and the first and second open end edges of the intermediate planar plane of +/−0-20°.

In yet an aspect of the test tube linear shake actuator the linear shake actuator can be a belt drive actuator, where the endless belt is driven by driving means at the first end and the second end and the vibration transfer engagement element is fixed to an outer perimeter of the endless belt.

In yet an aspect of the test tube linear shake actuator the vibration transfer engagement element can be arranged with the first and second open end edges of the intermediate planar plane with an angle between the longitudinal direction of the endless belt and the first and second open end edges of the intermediate planar plane of +/−0-20°.

In yet an aspect of the test tube linear shake actuator the linear shake actuator can be a linear motor actuator, where the primary of the linear motor may include the first end and the second end, and where the vibration transfer engagement element is the secondary or is fixed to the secondary.

In yet an aspect of the test tube linear shake actuator the vibration transfer engagement element can be arranged with the first and second open end edges of the intermediate planar plane with an angle between the longitudinal direction of the primary and the first and second open end edges of the intermediate planar plane of +/−0-20°.

In yet an aspect of the test tube linear shake actuator the linear motor can be one of: Synchronous, induction, homopolar, piezo electric, moving coil/moving magnet.

In yet an aspect of the test tube linear shake actuator the vibration transfer engagement element can be replaceable.

According to the present invention it is also disclosed a test tube linear shake actuator and carousel arrangement where the carousel arrangement is configured to rotate around a vertical axis of rotation, at least comprising:
a) a number of test tube holders arranged mutually equidistant at the perimeter of the carousel, the test tube holders being pivotably hinged to the carousel so as to provide a swinging bucket motion, and;
b) a test tube linear shake actuator linearly movable forward, X-direction, and in reverse, −X-direction, having a first and second end comprising:
c) a vibration transfer engagement element proximate to the first end during vibration transfer engagement, suitable for vibration engagement with test tubes,
d) a linear shake actuator driving means for moving the linear shake actuator in the X-direction and in the −X-direction, and
e) control means controlling motion of the vibration transfer engagement means.

According to another embodiment of the invention it is disclosed a method for vibration transfer from a vibration transfer engagement element to a test tube included in a carousel arrangement where the carousel arrangement is configured to rotate around a vertical axis of rotation and a number of test tube holders are arranged mutually equidistant at the perimeter of the carousel, the test tube holders being pivotably hinged to the carousel so as to provide a swinging bucket motion, at least comprising the steps of:
a) releasably arranging at least one test tube in one of the test tube holders, and sequentially
b) choosing a test holder with a test tube to be in vibration engagement with the vibration transfer element;
c) stopping the carousel so that the chosen test tube is next to the vibration transfer element in the rotational direction;
d) forwarding the vibration transfer engagement element in a radial direction until the vibration transfer element reaches a radial distance from the vertical axis of rotation adapted for vibration engagement with the chosen test tube,
e) rotate the carousel with the chosen test tube until it is radially in line with the vibration transfer engagement element;
i. vibrate the vibration transfer engagement element by linear driving means driving the vibration transfer engagement element reciprocally at least in a radial forward direction and in a radial backward direction, thereby transferring vibrations to the chosen test tube.

Other advantageous embodiments, aspects and details according to the present invention will become apparent by the accompanying claims.

### BRIEF DESCRIPTION OF THE DRAWINGS

In order to make the invention more readily understandable, the discussion that follows will refer to the accompanying drawings, in which

FIG. 1, shows a cell pretreating process instrument including a carousel arrangement with a number of test tube holders;

FIG. 2, shows test tube holder arrangement;

FIG. 3, shows a carousel arrangement including the test tube holder arrangement;

FIG. 4a shows a test tube linear shake actuator including a vibration transfer engagement element.

FIG. 4b shows an example of a vibration transfer engagement element seen from the side, as also shown in FIG. 4d;

FIG. 4c shows an example of a vibration transfer engagement element in perspective, as also shown in FIGS. 7a and 7b;

FIG. 4d shows an example of a vibration transfer engagement element where the distance A between opposite upright sidewalls are adjustable;

FIG. 4e shows a test tube linear shake actuator in a neutral position, including driving means, vibration transfer engagement element and test tube holder with test tube;

FIG. 5 shows the test tube linear shake actuator of FIG. 4 in an engagement position where the vibration transfer engagement element is in engagement with the test tube;

FIG. 6 shows the test tube linear shake actuator of FIG. 4 in a retracted position, that is; the test tube linear shake actuator is inside, (in a −X-direction) of the test tube and hence not in an engagement position for engagement between the vibration transfer engagement element and the test tube;

FIG. 7a shows several test tubes and a linear shake actuator with a vibration transfer engagement element, the vibration transfer engagement element is partially enclosing the test tube;

FIG. 7b shows a test tube in a swinging bucket holding arrangement seen in perspective,

FIG. 8 shows the same arrangement as FIG. 7a seen from above, and

FIG. 9 shows a linear electro motor with a vibration transfer engagement element which together forms a linear shake actuator, and

FIG. 10 shows a test tube linear shake actuator of chain driven type, a similar configuration is applied for belt drive, where belts replaces the chain and pulleys or sheaves replaces the sprockets

### DETAILED DESCRIPTION OF THE INVENTION

In the following, the present invention will be discussed by describing embodiments, and by referring to the accompanying drawings. However, people skilled in the art will realize other applications and modifications within the scope of the invention as defined in the enclosed independent claims.

In hospitals and labs centrifuging and mixing of test samples in test tubes using centrifuges is common, following a centrifuging step removal of supernatant in test tubes can be necessary. Vortex mixers generally carry out shaking of test tubes, and vortex is commonly used for the word shake or as in the context of this disclosure for vibration and shake.

When test samples are mixed into test tubes and centrifuged the centrifuging step can lead to phase separation and parts of the test samples can stick to the test tube. Normally, residues that has sticked to the test tube is loosened by manually shaking/vortexing the test tube.

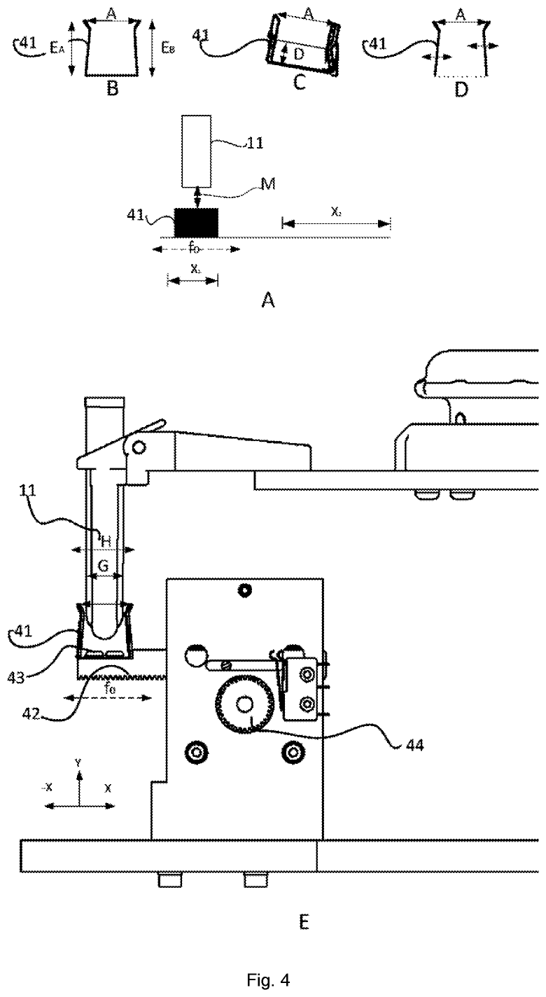

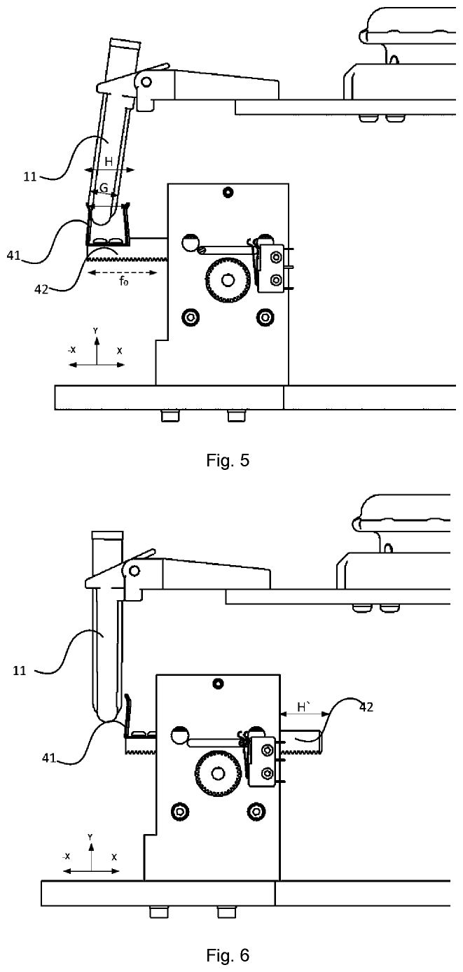

The present invention provides a test tube 11 vibration/vortexing transfer engagement element 41 (FIGS. 4a, b and c), a test tube linear shake actuator, a carousel arrangement and a test tube linear shake actuator and a method for transfer of vibration between a test tube vibration transfer engagement element 41 and a test tube 11. The carousel arrangement have holding means for holding test tubes 11 in a determined position at an outer periphery of the carousel. The test tubes 11 are pivotably hinged to the rim/outer periphery of the carousel, thereby providing a swinging bucket motion of the test tubes 11 during operation of the carousel.

As indicated above, it can be of interest to shake or titrate the test tubes 11. In the present invention, it is disclosed a shaking arrangement for shaking test tubes 11. The shaking process will vary according to several parameters such as the size of the test tube 11, the amount of the fluid in the test tube, the viscosity of the fluid, the viscosity of separated fluids, how the test samples have sticked to the tube 11 etc. Thus, it can be an advantage to provide control of the shaking process.

The principle behind the shaking process is to provide a vibration transfer engagement element (FIG. 4a), which in engagement with test tubes transfers vibrations to the test tubes. By introducing control means the frequency f₀ of the vibration of the engagement element can be controlled further, on off sequences for vibration of the vibration transfer elements can be controlled. The vibration control means can be programmed to provide a vast range of frequencies, sequences of vibration etc.

To prevent the test tubes 11, when in engagement with the vibration transfer engagement element 41, from an unrestricted pendulum movement caused by the vibration transfer engagement element (only restricted by gravity and friction), a blocking means can stop or restrict the pendulum movement and thereby create high acceleration for the test tube 11.

The vibration transfer engagement element 41 can be any type of element, which is given a mechanical vibration (acceleration/deceleration). The blocking means can be a mechanical hindrance or it can be of magnetic type. The engagement between the vibration transfer element 41 and the test tube 11 can be achieved by for example mechanically move the vibration transfer engagement element 41 into engagement with the test tube 11, or by moving the test tube 11 into engagement with the vibration transfer engagement element 41.

Movement of the vibration transfer engagement element 41 can be facilitated by a linear actuator 42, where the vibration transfer element 41 is fixed to the linear actuator 42 in such a way that it is possible to bring the vibration transfer engagement element 41 in contact with the test tube 11.

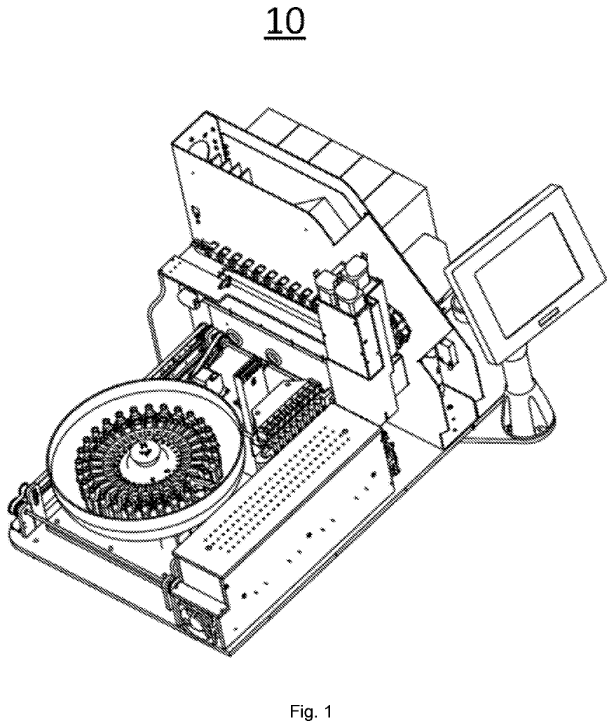

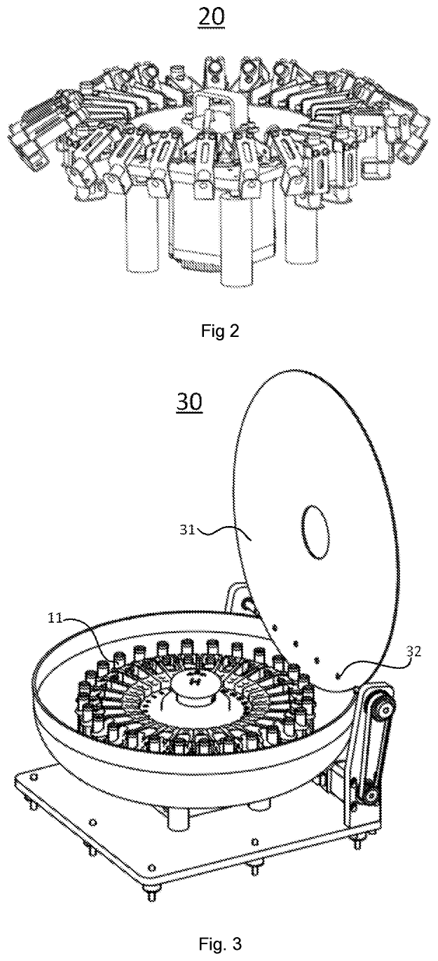

FIG. 1 shows an example of a carousel arrangement in an apparatus 10. A detail of the carousel 30 with an open lid 31 is shown in FIG. 3. FIG. 2 shows a detail of the carousel with suspension system for the test tubes, in the figure some test tubes is shown in lifted positions. It shall be noted that FIG. 2 is merely an example and the holding means for the test tubes 11 do not comply with those shown in FIGS. 4-8.

FIG. 4a shows a principle of a linear shake actuator including a vibration transfer engagement element 41. The vibration transfer engagement element transfer, M, vibrations between the vibration transfer engagement element and a test tube 11. The linear shake actuator has an active area X1 where vibration transfer takes place, and a retracted area X2 where a carousel can rotate freely without obstruction from the linear shake actuator.

FIG. 4b shows a blocking means in the form of a bracket 41, the bracket 41 has a first upright sidewall with a height E_{A} and a second upright sidewall opposite of the first upright sidewall with a height E_{B}. The distance between the free ends of the first and the second upright sidewalls is A. In between the sidewalls at their bottom end it is arranged a planar base.

FIG. 4c shows the blocking means of FIG. 4b seen in perspective. The planar base has a depth D. It can be seen that the upper free end of the upright sidewalls have curvatures to better adapt to the circular closed end of test tubes 11.

FIG. 4e shows a test tube 11 held in place by a suspension arrangement fixed to a rondel of the carousel arrangement. A linear actuator arm 42 with blocking means in the form of a bracket 41 is shown in close contact with the bottom/closed end of a test tube 11. The shown arrangement necessitates a linear movement forward and in reverse of the linear actuator 42, which is synchronised, with the rotational speed of the carousel and the positions of each individual test tube 11. During centrifuging the linear actuator arm 42 shown is in a retracted position. When a test tube 11 that shall be shaken is arriving radially close to the longitudinal axis of the linear actuator 42 and the previous test tube have passed the prolongation of the longitudinal axis of the linear actuator 42 the actuator arm 42 is moved in a forward direction so that the bracket is radially moved until it reaches a position that is open to receive a closed end of a test tube 11. FIG. 5 shows the same arrangement as FIG. 4e in a same sequence seen from another angle. In this example, it is shown a linear actuator of a mechanical rack and pinion type. The choice of a rack and pinion type is merely of illustrative purposes as many different types of linear actuators can be used.

FIG. 6 shows the linear actuator 42 in a retracted (reverse) position, which facilitates rotation of the carousel with test tubes 11.

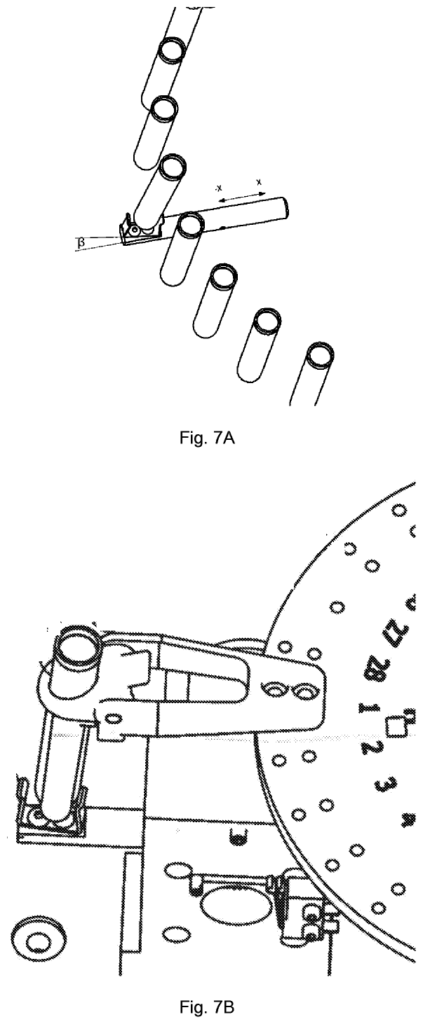

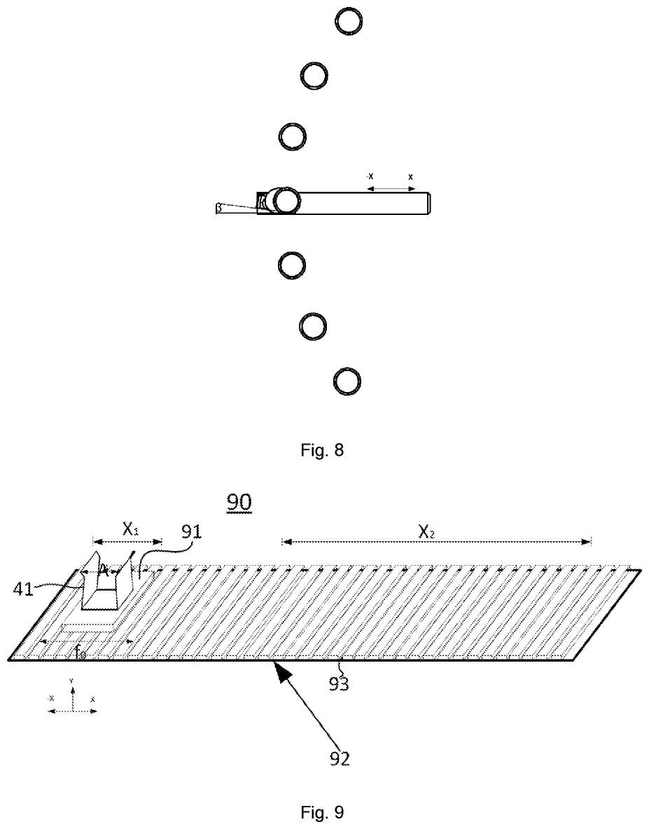

FIGS. 7a and 8 discloses test tubes 11 and the linear shake actuator 42 with its vibration transfer engagement element 41. In both figures the linear shake actuator 42 is in a “receive” position, that is, the vibration transfer engagement element 41 is open to receive the bottom end of a test tube 11. FIG. 7a is in perspective whilst FIG. 8 is seen from above. The figures clearly shows that the linear shake actuator arm 42 must be in a retracted position when test tubes are rotating with a carousel arrangement. FIG. 7b shows a test tube 11 in a swinging bucket holding arrangement and a part of the outer periphery of a carousel seen in perspective.

FIG. 9 shows an example of a linear electro motor shake actuator 90.

In a basic embodiment (FIG. 4a) of a vibration, transfer engagement element the vibration transfer engagement element 41 is adapted to be linearly movable forward, i.e. in an X-direction, and in reverse, an −X-direction. The IXI-direction is shown parallel with the radial direction of the vertical axis of rotation for the carousel. Facilitation of linear movement in X-directions provides for engagement between the vibration transfer engagement element 41 and a test tube 11. The X-direction coincides with the radial direction of the carousel. A vibration transfer engagement element linear driving means can be used for moving the vibration transfer engagement element 41 in radially forward and in reverse. The vibration transfer engagement element 41 can include control means to control forward distance travel and reverse distance travel (H) of the linear vibration transfer engagement element 41, time sequences for travel between extremities in x-direction and in −X-direction of the linear vibration transfer engagement element 41, and acceleration of the of the linear vibration transfer engagement element 41.

The vibration transfer engagement element is 41, as mentioned above, is adapted to be brought into engagement M with a second object such as a test tube 11. A linear actuator with a vibration transfer engagement element 41 attached to it can be used as a test tube linear shake actuator, which is linearly movable forward, X-direction, and in reverse, −X-direction. In an arrangement with a carousel, the |X|-direction coincides with the radial direction of the carousel. A linear actuator will typically have a first and second end. In one embodiment, a vibration transfer engagement element 41 is arranged proximate to the first end of the linear actuator during vibration transfer engagement M. It shall be appreciated that the vibration transfer engagement element 41 can move together with a linear actuator or it can move “on” a linear actuator in the same manner as a secondary 91 of a linear motor (FIG. 9). The linear actuator can be a rod 42, which is movable in a radial direction, where the movement is caused by driving means and where the vibration transfer engagement element 41 is fixed or releasably fixed to the rod (rack) 42.

The engagement between the vibration transfer engagement element 41 and the second object shall be controlled by control means. In the event that residues sticked to the walls of a test tube 11 shall be released in a controlled way, it is necessary to have full control of the engagement between the test tube 11 and the vibration transfer engagement element 41. The speed, acceleration, travel distance H, frequency f₀, etc. of the vibration transfer engagement element 41 shall be controlled by a control means. The control means can be programmable. The control means shall at least control:
The forward distance travel and reverse distance travel H of the linear vibration transfer engagement element 41;
time sequences for travel between extremities in X-direction and in −X-direction of the linear vibration transfer engagement element 41, and
acceleration of the of the linear vibration transfer engagement element 41.

In the following different embodiments and variants of the invention is disclosed. Firstly it is focused on the vibration transfer element 41 as such, thereafter it is focused on linear actuators in combination with vibration transfer engagement element 41, different arrangement which includes carousels are disclosed as well as a method for operation of an arrangement for shaking test tubes 11 using a vibration transfer engagement element 41, a linear actuator and a carousel.

### First Embodiment of a Vibration Transfer Engagement Element

In a first embodiment of a vibration transfer engagement element 41 the element is adapted to be moved in a radial direction as indicated above to bring test tubes 11 in contact with a vibration transfer engagement element 41 and also to provide free rotation of a carousel by retracting the vibration transfer engagement element 41. In this first embodiment, the vibration transfer engagement element can be a U-shaped bracket 41. A U-shaped bracket embodiment is shown in FIGS. 4b and 4c. The bracket 41 can, according to the first embodiment be made by a first sheet metal side edge opposite to a second sheet metal side edge, together forming the side edges of the bracket. The first sheet metal side edge has a free end and a base end. In the FIGS. 4b and 4c the free end faces vertically upward and the base end faces downward. The second sheet metal side edge has in a similar fashion as the first sheet metal a free end and a base end. Between the base ends of the first sheet metal side edge and the base end of the second sheet metal side edge it is an intermediate base area with a first and a second open end. The first and second open end is adapted to receive the lower end of a test tube 11, whilst the first and the second sheet metal side edges is adapted to block radial pendulum movement of the test tube 11 beyond a predefined limit. The predefined travel distance (limit) H is determined by the distance A between the first and the second sheet metal side edges and the height of the first E_{A} and the second E_{B} sheet metal side edges. Obviously, the distance A between the first and the second sheet metal side edges must be bigger than the outer diameter G of the bottom end of a test tube 11 to be received by the first and the second open end of the intermediate base area (A>G).

The vibration transfer engagement element 41 can more precisely be defined as having an opening A between the free end of the first sheet metal side edge and the free end of the second sheet metal side edge that is larger than the diameter of a closed end of a test tube and smaller than an axial length of the test tube. The height of the upstanding first and second sheet metal side is E_{A} and E_{B} respectively. E_{A} and E_{B} can be between 5 mm and 25 mm. The depth of the open ends of the intermediate base is D. The depth D is the distance between the first and the second open end of the intermediate base area. D can be within the range of 1-15 mm.

First Variant

According to the first embodiment of the vibration transfer engagement element 41, it is provided a first variant of the vibration transfer engagement element. The first variant of the first embodiment of the vibration transfer engagement element 41 provides side edges that are mutually movable in a radial direction (FIG. 4d), thereby achieving an adjustable opening width A. The adjustable opening width facilitates use of test tubes with different relevant diameters. Moreover, it dictates the pendulum travel distance of test tubes that are in engagement with the vibration transfer engagement element. The width A is also related to the acceleration forced on the test tube due to engagement/collision with the side edges of the vibration transfer engagement element.

Second Variant

According to the first embodiment of the vibration transfer engagement element, it is provided a second variant of the vibration transfer engagement element 41. In this second variant, the vibration transfer engagement element 41 is configured to be replaceable.

It can be replaceable by the use of detachable fastening means, such as screws 43 and nuts, screws 43 and threads in a receiving part such as a linear actuator bar/rod 42. Other detachable fastening means such as snap fit, magnetic attachment, male female grooves or openings and tongue and grooves among others can be used.

Third Variant

According to the first embodiment of the vibration transfer engagement element 41 it is provided a third variant of the vibration transfer engagement element 41, namely a vibration transfer engagement element 41 where the opposite sides of the first side edge and the second side edge are provided with a damping material.

The damping material facilitates customising the impact exerted on test tubes 11 when the test tubes hits the first or second side edge of a vibration transfer engagement element 41 according to the first embodiment of the vibration transfer engagement element 41.

### Second Embodiment of a Vibration Transfer Engagement Element

In a second embodiment of a vibration transfer engagement element 41 the element is adapted to be moved in a radial direction as indicated above to bring test tubes 11 in contact with the vibration transfer engagement element 41 and also to provide free rotation of a carousel by retracting the vibration transfer engagement element 41. In this second embodiment, the vibration transfer engagement element can be a U-shaped bracket. A U-shaped bracket embodiment is shown in FIGS. 4b-4e. The bracket can, according to the second embodiment be a made by a U-shaped bracket with a first planar side edge opposite to a second planar side edge that together forms the side edges (upright side walls) of the bracket. The first planar side edge has a free end and a base end. In the FIGS. 4b-4e the free end faces vertically upward and the base end faces downward. The second planar side edge has in a similar fashion as the first sheet metal a free end and a base end. Between the base ends of the first planar side edge and the base end of the second planar side edge it is an intermediate base area with a first and a second open end. The first and second open end is adapted to receive the lower end of a test tube 11, whilst the first and the second planar side edge is adapted to block radial pendulum movement of the test tube beyond a predefined limit. The predefined travel distance (limit) H is among others determined by the distance between the first and the second planar side edge. The distance A between the first and the second sheet metal side edges must be bigger than the outer diameter G of the bottom end of a test tube 11 to be received by the first and the second open end of the intermediate base area.

The vibration transfer engagement element 41 can more precisely be defined as having an opening A between the free end of the first planar side edge and the free end of the second planar side edge that is larger than the diameter of a closed end of a test tube and smaller than an axial length of the test tube. The height of the upstanding first and second planar side is E_{A} and E_{B} respectively. E_{A} and E_{B} can be between 5 mm and 25 mm. The vibration transfer engagement element has a depth D. The depth D is the distance between the first and the second open end of the intermediate basal area. D can be within the range of 1-15 mm.

First Variant

According to the second embodiment of the vibration transfer engagement element, it is provided a first variant of the vibration transfer engagement element 41. The first variant of the second embodiment of the vibration transfer engagement element 41 provides side edges that are mutually movable in a radial direction, thereby achieving an adjustable opening width A (FIG. 4d). The adjustable opening width facilitates use of test tubes with different relevant diameters. Moreover, it dictates the pendulum travel distance of test tubes that are in engagement with the vibration transfer engagement element. The width A is also related to the acceleration forced on the test tube due to engagement/collision with the side edges of the vibration transfer engagement element.

Second Variant

According to the second embodiment of the vibration transfer engagement element 41, it is provided a second variant of the vibration transfer engagement element. In this second variant, the vibration transfer engagement element is configured to be replaceable.

It can be replaceable by the use of detachable fastening means, such as screws 43 and nuts, screws 43 and threads in a receiving part such as a linear actuator bar/rod 42. Other detachable fastening means such as snap fit, magnetic attachment, male female grooves or openings and tongue and grooves among others can be used.

Third Variant

According to the second embodiment of the vibration transfer engagement element 41 it is provided a third variant of the vibration transfer engagement element, namely a vibration transfer engagement element where the opposite sides of the first side edge and the second side edge are provided with a damping material.

The damping material facilitates customising the impact exerted on test tubes 11 when the test tubes hits the first or second side edge of a vibration transfer engagement element according to the second embodiment of the vibration transfer engagement element 41.

### Third Embodiment of a Vibration Ttransfer Engagement Element

In a third embodiment of a vibration transfer engagement element the element is adapted to be moved in a radial direction as indicated above to bring test tubes 11 in contact with the vibration transfer engagement element 41 and also to provide free rotation of a carousel by retracting the vibration transfer engagement element. In this third embodiment the vibration transfer engagement element 41 can be a buzzer, i.e. in itself an element that can be forced or stimulated to vibrate itself.

The buzzer can be one of: electromechanical, mechanical and piezoelectric.

### Fourth Embodiment of a Vibration Transfer Engagement Element

In a fourth embodiment of a vibration transfer engagement element the element is adapted to be moved in a radial direction as indicated above to bring test tubes 11 in contact with the vibration transfer engagement element 41 and also to provide free rotation of the carousel by retracting the vibration transfer engagement element. In this fourth embodiment, the vibration transfer engagement element 41 can be a vibration transfer diaphragm. The diaphragm can be excited to move with a regulated amplitude and frequency. A linear motor can drives the diaphragm. The principle can be that of a loudspeaker, i.e. alternate current in a coil, where the coil is magnetically in engagement with a magnet, will induce a force F on the coil, making it a moving coil.

The linear motor can be one of: a moving coil type, (of the type known from loudspeakers), and a moving magnet type.

### Fifth Embodiment of a Vibration Transfer Engagement Element

In a fifth embodiment of a vibration transfer engagement element 41 the element is adapted to be moved in a radial direction as indicated above to bring test tubes 11 in contact with the vibration transfer engagement element 41 and also to provide free rotation of a carousel by retracting the vibration transfer engagement element 41. In this fifth embodiment, the vibration transfer engagement element is the secondary 91 in a linear electro motor.

A linear motor is functionally the same as a rotary electric motor where the rotor 91 is substituted with a moving secondary and the stator is spread out flat, comparable with a stator having an infinite radius. The “rotor” takes the form of a moving platform known as the “secondary 91.” Where a rotary motor would spin around and re-use the same magnetic pole faces again, the magnetic field structures of a linear motor are physically repeated across the length of the primary 92 i.e. the stator. A “bonus” effect of the linear motor is that a levitating effect is created resulting in a low friction movement of the secondary 91.

The secondary 91 can be brought into engagement with test tubes in a controlled manner, i.e. acting as the vibration transfer engagement element according to the fifth embodiment of the vibration transfer engagement element.

### First Embodiment of a Test Tube Linear Shake Actuator

In a first embodiment of a test tube linear shake actuator it is described a linear driving means for linear movements of a vibration transfer engagement element, FIG. 4a. The linear shake actuator has a first and second end. At the first end, it can be arranged a vibration transfer engagement element 41. The vibration transfer engagement element 41 will normally be fixed to the first end, alternatively be releasably fixed to the first end. However, in an alternative variant 5 it is described a linear motor variant, FIG. 9, the vibration transfer engagement element 41 is the secondary 91 of a linear motor, the vibration transfer engagement element 41 itself can be moved in an X-direction and in a −X-direction, whilst the primary 92 is fixed. The first end of the primary corresponds with the radially remote end whilst the second end of the primary corresponds to the radially near end of the primary.

According to the first embodiment of the test tube linear shake actuator the linear shake actuator comprises a rack and pinion arrangement, where the rack 42 includes the first and the second end, and where the pinion 44 is in engagement with the rack for forward, X-direction, and reverse motion, −X-direction, of the vibration transfer engagement element.

First Variant of the First Embodiment of the Linear Shake Actuator

In the first variant of the first embodiment of the linear shake actuator, the vibration transfer engagement element 41 corresponds with the first embodiment of the vibration transfer engagement element.

The vibration transfer engagement element 41 can be arranged with the first and second open end edges of the intermediate planar base parallel to the longitudinal direction of the rack.

However, the vibration transfer engagement element can also be arranged with the first and second open end edges of the intermediate planar base with an angle β between the longitudinal direction of the rack and the first and second open end edges of the intermediate planar base of +/−0-20°.

The vibration transfer engagement element 41 can be rotatably fixed to the first end of the rack through a swivel mount or in another rotatable manner. The possibility to rotate the bracket around a vertical axis through the rack can facilitate fine-tuning of the vibration transfer as well as the entry and exit of test tubes of the U-shaped bracket vibration transfer engagement element.

The side edges of the U-shaped vibration transfer engagement element 41 can be mutually movable in X-direction and −X-direction, thereby achieving an adjustable opening width A.

The vibrations transfer engagement element can be replaceable, in the same manner as indicated above.

Second Variant of the First Embodiment of the Linear Shake Actuator

In the second variant of the first embodiment of the linear shake actuator, the vibration transfer engagement element 41 corresponds with the second embodiment of the vibration transfer engagement element.

The vibration transfer engagement element 41 can be arranged with the first and second open end edges of the intermediate planar plane parallel to the longitudinal direction of the rack.

However, the vibration transfer engagement element can also be arranged with the first and second open end edges of the intermediate planar plane with an angle β between the longitudinal direction of the rack and the first and second open end edges of the intermediate planar plane of +/−0-20°.

The vibration transfer engagement element 41 can be rotatably fixed to the first end of the rack through a swivel mount or in another rotatable manner. The possibility to rotate the bracket around a vertical axis through the rack can facilitate fine-tuning of the vibration transfer as well as the entry and exit of test tubes of the U-shaped bracket vibration transfer engagement element.

The side edges of the U-shaped vibration transfer engagement element can be mutually movable in X-direction and −X-direction, thereby achieving an adjustable opening width A.

The vibrations transfer engagement element can be replaceable, in the same manner as indicated above.

Third Variant of the First Embodiment of the Linear Shake Actuator

In the third variant of the first embodiment of the linear shake actuator, the vibration transfer engagement element 41 corresponds with the third embodiment of the vibration transfer engagement element.

Fourth Variant of the First Embodiment of the Linear Shake Actuator

In the fourth variant of the first embodiment of the linear shake actuator, the vibration transfer engagement element 41 corresponds with the fourth embodiment of the vibration transfer engagement element.

Fifth Variant of the First Embodiment of the Linear Shake Actuator

In the fifth variant of the first embodiment of the linear shake actuator, the vibration transfer engagement element 41 corresponds with the fifth embodiment of the vibration transfer engagement element.

In the fifth variant, the vibration transfer engagement element can be the secondary 91 of a linear electro motor in the form of a carriage, which at least can move in an X-direction and in an −X-direction. The carriage can include for example a U-shaped bracket as described in the first and second embodiment of the vibration transfer engagement element above. Vibration is enabled by changing the travel direction of the secondary 91 so that for example a U-shaped bracket which has received the bottom of a test tube 11 with its upright side edges bumps into the test tube and thereby transfers vibration M from the vibration transfer engagement element 41 to the test tube 11.

### Second Embodiment of a Test Tube Linear Shake Actuator

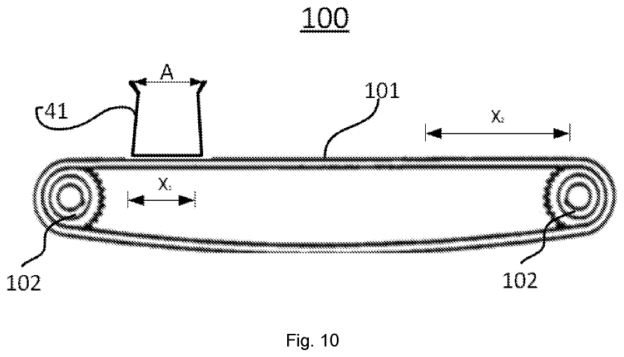

In the second embodiment of the test tube linear shake actuator the linear shake actuator is a chain drive actuator (FIG. 10) with roller chain 101 and sprockets 102. The linear shake actuator has a first and second end. The endless chain 102 can be driven by driving means at the first end and/or the second end and the vibration transfer engagement element 41 can be fixed to an outer perimeter of the endless chain. The chain 101 can be driven a predetermined distance in X-direction and in −X-direction.

First Variant of the Second Embodiment of the Linear Shake Actuator

In the first variant of the second embodiment of the linear shake actuator, the vibration transfer engagement element 41 corresponds with the first embodiment of the vibration transfer engagement element.

The vibration transfer engagement element 41 can be arranged with the first and second open end edges of the intermediate planar base parallel to the longitudinal direction of the chain.

However, the vibration transfer engagement element can also be arranged with the first and second open end edges of the intermediate planar plane with an angle between the longitudinal direction of the chain 101 and the first and second open end edges of the intermediate planar base of β=+/−0-20°.

The vibration transfer engagement element 41 can be rotatably fixed to the first end of the rack through a swivel mount or in another rotatable manner. The possibility to rotate the bracket around a vertical axis through the rack can facilitate fine-tuning of the vibration transfer as well as the entry and exit of test tubes of the U-shaped bracket vibration transfer engagement element 41.

The side edges of the U-shaped vibration transfer engagement element 41 can be mutually movable in X-direction and −X-direction, thereby achieving an adjustable opening width A.

The vibrations transfer engagement element can be replaceable, in the same manner as indicated above.

Second Variant of the Second Embodiment of the Linear Shake Actuator

In the second variant of the second embodiment of the linear shake actuator, the vibration transfer engagement element 41 corresponds with the second embodiment of the vibration transfer engagement element.

The vibration transfer engagement element 41 can be arranged with the first and second open end edges of the intermediate planar base parallel to the longitudinal direction of the chain 101.

However, the vibration transfer engagement element can also be arranged with the first and second open end edges of the intermediate planar base with an angle between the longitudinal direction of the chain 101 and the first and second open end edges of the intermediate planar plane of β=+/−0-20°.

The vibration transfer engagement element 41 can be rotatably fixed to the first end of the rack through a swivel mount or in another rotatable manner. The possibility to rotate the bracket around a vertical axis through the rack can facilitate fine-tuning of the vibration transfer as well as the entry and exit of test tubes of the U-shaped bracket vibration transfer engagement element 41.

The side edges of the U-shaped vibration transfer engagement element 41 can be mutually movable in X-direction and −X-direction, thereby achieving an adjustable opening width A.

The vibrations transfer engagement element 41 can be replaceable, in the same manner as indicated above.

Third Variant of the Second Embodiment of the Linear Shake Actuator

In the third variant of the second embodiment of the linear shake actuator, the vibration transfer engagement element 41 corresponds with the third embodiment of the vibration transfer engagement element 41.

Fourth Variant of the Second Embodiment of the Linear Shake Actuator

In the fourth variant of the second embodiment of the linear shake actuator, the vibration transfer engagement element 41 corresponds with the fourth embodiment of the vibration transfer engagement element 41.

### Third Embodiment of a Test Tube Linear Shake Actuator

According to the third embodiment of the test tube linear shake actuator it is provided a belt drive actuator. The configuration of the belt drive actuator corresponds to that of the endless chain (FIG. 10) except that the chain 101 is swapped with a belt. In addition, the driving wheels 102 will necessarily differ to get into engagement with the belt or chain. Single V-belts and double V-belts can be used as well as multirib belts and timing belts.

The first to fourth variant of the second embodiment also applies to the third embodiment of the test tube linear shake actuator.

### Fourth Embodiment of a Test Tube Linear Shake Actuator

According to a fourth embodiment of the test tube linear shake actuator it is provided a linear motor actuator. The primary 92 of the linear motor includes a first and a second end. A secondary 91 can travel between the first and the second end. The primary 92 can be provided with tracks to guide the secondary 91. The vibration transfer engagement element 41 can be the secondary or can be fixed or releasably fixed to the secondary.

The linear motor can be anyone of: Synchronous, induction, homopolar, piezo electric, moving coil/moving magnet.

First Variant of the Fourth Embodiment of the Linear Shake Actuator

In the first variant of the fourth embodiment of the linear shake actuator, the vibration transfer engagement element 41 corresponds with the first embodiment of the vibration transfer engagement element. The U-shaped bracket can be fixed to the secondary.

The vibration transfer engagement element 41 can be arranged with the first and second open end edges of the intermediate planar plane parallel to the longitudinal direction of the primary.

However, the vibration transfer engagement element can also be arranged with the first and second open end edges of the intermediate planar plane with an angle between the longitudinal direction of the primary and the first and second open end edges of the intermediate planar plane of β=+/−0-20°.

The vibration transfer engagement element 41 can be rotatably fixed to the secondary through a swivel mount or in another rotatable manner. The possibility to rotate the bracket around a vertical axis through the primary can facilitate fine-tuning of the vibration transfer as well as the entry and exit of test tubes of the U-shaped bracket vibration transfer engagement element.

The side edges of the U-shaped vibration transfer engagement element 41 can be mutually movable in X-direction and −X-direction, thereby achieving an adjustable opening width A.

The vibration transfer engagement element 41 can be replaceable, in the same manner as indicated above.

Second Variant of the Fourth Embodiment of the Linear Shake Actuator

In the second variant of the fourth embodiment of the linear shake actuator, the vibration transfer engagement element 41 corresponds with the second embodiment of the vibration transfer engagement element 41 as taking the shape of an “U”.

The vibration transfer engagement element can be arranged with the first and second open end edges of the intermediate planar plane parallel to the longitudinal direction of the primary 92.

However, the vibration transfer engagement element 41 can also be arranged with the first and second open end edges of the intermediate planar plane with an angle between the longitudinal direction of the primary 92 and the first and second open end edges of the intermediate planar base of β=+/−0-20°.

The vibration transfer engagement element 41 can be rotatably fixed to the secondary 91 through a swivel mount or in another rotatable manner. The possibility to rotate the bracket around a vertical axis through the secondary 91 can facilitate fine-tuning of the vibration transfer as well as the entry and exit of test tubes of the U-shaped bracket vibration transfer engagement element.

The side edges of the U-shaped vibration transfer engagement element can be mutually movable in X-direction and −X-direction, thereby achieving an adjustable opening width A.

The vibrations transfer engagement element 41 can be replaceable, in the same manner as indicated above.

Third Variant of the Fourth Embodiment of the Linear Shake Actuator

In the third variant of the fourth embodiment of the linear shake actuator, the vibration transfer engagement element 41 corresponds with the third embodiment of the vibration transfer engagement element.

The vibration transfer engagement element is fixed to the secondary 91.

Fourth Variant of the Fourth Embodiment of the Linear Shake Actuator

In the fourth variant of the fourth embodiment of the linear shake actuator the vibration transfer engagement element corresponds with the fourth embodiment of the vibration transfer engagement element 41.

The vibration transfer engagement element 41 is fixed to the secondary 92.

### REFERENCE LIST

| A | An opening A between a free end of a first |
|---|---|
| | upright side edge and a free end of a |
| | second side edge of a U-shaped bracket. |
| | A > G |
| E_{A} | Height of first upright side edge, 5-25 mm |
| E_{B} | Height of a second upright side edge, 5-25 mm |
| D | The distance between the first and the second |
| | open end of an intermediate basal area of a |
| | U-shaped bracket, 1-15 mm |
| G | Width of closed end of test tube 11 |
| H | Travel distance in X and −X direction of |
| | test tube vibration transfer element 41 |
| f₀ | Vibration frequency of test tube vibration |
| | transfer engagement element 41 |
| M | Vibration transfer |
| X₁ | Active area, area where vibration transfer |
| | between vibration transfer engagement element |
| | 41 and test tubes 11 finds place |
| X₂ | Retracted area. Passive area where carousel |
| | can rotate without obstruction from vibration |
| | transfer engagement element |
| β | Angle between intermediate planar plane of |
| | test tube vibration transfer element 41 |
| | and the longitudinal axis of the element 43. |
| 10 | Apparatus with a carousel arrangement |
| 11 | Test tube |
| 20 | Carousel/centrifuge of carousel centrifuge arrangement |
| 31 | Lid/lock |
| 41 | A test tube vibration transfer engagement element |
| 42 | Rack in a rack and pinion arrangement, |
| | i.e. an example of a linear actuator. |
| 43 | Fastening means of the test tube vibration |
| | transfer engagement element to the rack 42 |
| 44 | Pinion in a rack and pinion arrangement. |
| 90 | Linear electro motor shaker arrangement |
| 91 | Secondary of linear electro motor |
| 92 | Primary of linear electro motor |
| 93 | Grooves in primary adapted to receive motor windings |
| 100 | A test tube linear shake actuator of chain driven type. |
| | The chain can be replaced with belts to achieve a test |
| | tube linear shake actuator of a belt driven type. |
| 101 | Chain or belt in a belt driven system |
| 102 | Sprocket or sheave/pulley in belt drive systems. |

1. A test tube vibration transfer engagement element adapted to be linearly movable forward, X-direction, and in reverse, −X-direction, adapted to engage with a test tube and thereby transfer vibrations in X-direction and −X-direction to test tubes.

2. A vibration transfer engagement element according to claim 1, where the vibration transfer engagement element is a U-shaped bracket with a first planar side edge opposite to a second planar side edge that forms the side edges of the bracket, the first planar side edge has a free end and a base end, the second planar side edge has a free end and a base end, between the base end of the first planar side edge and the base end of the second planar side edge it is an intermediate planar piece with a first and a second open end, where the transfer engagement element has:
a) an opening A between the free end of the first planar side edge and the free end of the second planar side edge that is larger than the diameter of a closed end of a test tube and smaller than an axial length of the test tube,
b) a height E_{A} between 5 mm and 25 mm and E_{B} between 5 mm and 25 mm, and
c) a width D within the range of 1-15 mm.

3. A vibration transfer engagement element according to claim 2, where the vibration transfer engagement element is a U-shaped bracket made of sheet metal.

4. A vibration transfer engagement element according to claim 2, where the side edges are mutually movable in X-direction and −X-direction, thereby achieving an adjustable opening width A.

5. A vibration transfer engagement element according to claim 1, where the vibration transfer engagement element is configured to be replaceable.

6. A vibration transfer engagement element according to claim 1, where the opposite sides of the first side edge and the second side edge are provided with a damping material.

7. A vibration transfer engagement element according to claim 1, where the transfer engagement element is a buzzer.

8. A vibration transfer engagement element according to claim 7, where the buzzer is one of: electromechanical, mechanical and piezoelectric.

9. A vibration transfer engagement element according to claim 1, where the transfer engagement element comprises a vibration transfer diaphragm.

10. A vibration transfer engagement element according to claim 9, where a linear motor drives the diaphragm.

11. A vibration transfer engagement element according to claim 10, the linear motor is one of:
a) a moving coil type, of the type known from loudspeakers, and
b) a moving magnet type.

12. A vibration transfer engagement element according to claim 1, where the transfer engagement element includes a driving means being a secondary of a linear motor.

13. A test tube linear shake actuator linearly movable forward, X-direction, and in reverse, −X-direction, having a first and second end comprising:
a) a vibration transfer engagement element proximate to the first end for vibration transfer engagement, suitable for vibration engagement with test tubes,
b) linear shake actuator driving means for moving the linear shake actuator in the X-direction and in the −X-direction, and
c) control means controlling:
i. forward distance travel and reverse distance travel of the linear vibration transfer engagement element;
ii. time sequences for travel between extremities in x-direction and in −X-direction of the linear vibration transfer engagement element, and
iii. acceleration of the linear vibration transfer engagement element.

14. A test tube linear shake actuator according to claim 13, where the transfer engagement element is a U-shaped bracket with a first planar side edge opposite to a second planar side edge that forms the side edges of the bracket, the first planar side edge has a free end and a base end, the second planar side edge has a free end and a base end, between the base end of the first planar side edge and the base end of the second planar side edge it is an intermediate planar piece with a first and a second open end, where the transfer engagement element has:
a) an opening A between the free end of the first planar side edge and the free end of the second planar side edge that is larger than the diameter of a closed end of a test tube and smaller than an axial length of the test tube,
b) a height E_{A} between 5 mm and 25 mm and E_{B} between 5 mm and 25 mm, and
c) a width D within the range of 1-15 mm.

15. A test tube linear shake actuator according to claim 14, where the vibration transfer engagement element is a U-shaped bracket made of sheet metal.

16. A test tube linear shake actuator according to claim 14, where the side edges are mutually movable in X-direction and −X-direction, thereby achieving an adjustable opening width A.

17. A test tube linear shake actuator according to claim 13, where the linear shake actuator further comprises a rack and pinion arrangement, where the rack includes the first and the second end, and where the pinion is in engagement with the rack for forward and reverse motion of the vibration transfer engagement element.

18. A test tube linear shake actuator according to claim 17, where the vibration transfer engagement element is arranged with the first and second open end edges of the intermediate planar plane parallel to the longitudinal direction of the rack.

19. A test tube linear shake actuator according to claim 17, where the vibration transfer engagement element is arranged with the first and second open end edges of the intermediate planar plane with an angle between the longitudinal direction of the rack and the first and second open end edges of the intermediate planar plane of +/−0-20°.

20. A test tube linear shake actuator according to claim 13, where the linear shake actuator is a chain drive actuator, where the endless chain is driven by driving means at the first end and the second end and the vibration transfer engagement element is fixed to an outer perimeter of the endless chain.

21. A test tube linear shake actuator according to claim 20, where the vibration transfer engagement element is arranged with the first and second open end edges of the intermediate planar plane with an angle between the longitudinal direction of the endless chain and the first and second open end edges of the intermediate planar plane of +/−0-20°.

22. A test tube linear shake actuator according to claim 13, where the linear shake actuator is a belt drive actuator, where the endless belt is driven by driving means at the first end and the second end and the vibration transfer engagement element is fixed to an outer perimeter of the endless belt.

23. A test tube linear shake actuator according to claim 20, where the vibration transfer engagement element is arranged with the first and second open end edges of the intermediate planar plane with an angle between the longitudinal direction of the endless belt and the first and second open end edges of the intermediate planar plane of +/−0-20°.

24. A test tube linear shake actuator according to claim 13, where the linear shake actuator is a linear motor actuator.

25. A test tube linear shake actuator according to claim 24, where the primary of the linear motor includes the first end and the second end, and where the vibration transfer engagement element is the secondary or is fixed to the secondary.

26. A test tube linear shake actuator according to claim 25, where the vibration transfer engagement element is arranged with the first and second open end edges of the intermediate planar plane with an angle between the longitudinal direction of the primary and the first and second open end edges of the intermediate planar plane of +/−0-20°.

27. A test tube linear shake actuator according to claim 25, where the linear motor is one of: synchronous, induction, homopolar, piezo electric, moving coil/moving magnet.

28. A test tube linear shake actuator according to claim 13, where the vibration transfer engagement element is replaceable.

29. A test tube linear shake actuator and carousel arrangement where the carousel arrangement is configured to rotate around a vertical axis of rotation, at least comprising:
a) a number of test tube holders arranged mutually equidistant at the perimeter of the carousel, the test tube holders being pivotably hinged to the carousel so as to provide a swinging bucket motion, and;
b) a test tube linear shake actuator linearly movable forward, X-direction, and in reverse, −X-direction, having a first and second end comprising:
i. a vibration transfer engagement element proximate to the first end during vibration transfer engagement, suitable for vibration engagement with test tubes,
ii. a linear shake actuator driving means for moving the linear shake actuator in the X-direction and in the −X-direction, and
iii. control means controlling motion of the vibration transfer engagement means.

30. A method for vibration transfer from a vibration transfer engagement element to a test tube included in a carousel arrangement where the carousel arrangement is configured to rotate around a vertical axis of rotation and a number of test tube holders are arranged mutually equidistant at the perimeter of the carousel, the test tube holders being pivotably hinged to the carousel so as to provide a swinging bucket motion, at least comprising the steps of:
a) releasably arranging at least one test tube in one of the test tube holders, and sequentially;
b) choosing a test holder with a test tube to be in vibration engagement with the vibration transfer element;
c) stopping the carousel so that the chosen test tube is next to the vibration transfer element in the rotational direction;
d) forwarding the vibration transfer engagement element in a radial direction until the vibration transfer element reaches a radial distance from the vertical axis of rotation adapted for vibration engagement with the chosen test tube;
e) rotate the carousel with the chosen test tube until it is radially in line with the vibration transfer engagement element;
i. vibrate the vibration transfer engagement element by linear driving means driving the vibration transfer engagement element reciprocally at least in a radial forward direction and in a radial backward direction, thereby transferring vibrations to the chosen test tube.
